(19) United States
(12) Patent Application Publication
(10) Pub. No.: US 2008/0136828 A1
(43) Pub. Date: Jun. 12, 2008

(54) Remote Access Device

(75) Inventor: Chih-Hsien Chang, Hsichih (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Aten International Co., Ltd., Hsichih (TW)

(21) Appl. No.: 11/608,022

(22) Filed: Dec. 7, 2006

(51) Int. Cl. G06F 13/14

(52) U.S. Cl. 345/520

(57) ABSTRACT

A remote access device is installed on a first computing device with a first video source to receive a first video signal. A second computing device may access the first computing device via a network. The remote access comprises a second video source to provide a second video signal, a controller, a switch controlled by the controller to select one of the first video signal and the second video signal based on an instruction from the second computing device and a network interface coupled to the switch and the controller to transmit one of the first video signal and the second video signal, selected by the switch, to the second computing device.

### FIELD OF THE INVENTION

The present invention relates to an access device, and more particularly, to a remote access device.

### BACKGROUND

A personal computer with two display cards may simultaneously operate two displays. For example, the two displays may show the same information or be combined together to create one virtual display that is called an extended display.

A typical keyboard, video and mouse (KVM) switch card might also have display functionality. However, when the KVM switch card is installed in a motherboard with a display card or a on-board graphic chip in a server, either the KVM switch cards or the display card has to disable its display functionality due to the inherent design of the KVM switch card to avoid a wrong display being shown by the server. In other words, even though a display card and a KVM switch card with video source are installed in a server, only one of the two displays may show information.

Therefore, a KVM switch card that may work with a display card is required.

### SUMMARY OF THE PREFERRED EMBODIMENTS

In one preferred embodiment of the present invention, a remote access device is installed on a first computing device with a first video interface to receive a first video signal. A second computing device may access the first computing device. The remote access comprises a second video source, to provide a second video signal, a controller, a switch controlled by the controller to select either the first video signal or the second video signal, based on an instruction from the second computing device and a network interface, coupled to the switch and the controller, to transmit either the first video signal or the second video signal, selected by the switch, to the second computing device.

In the other embodiment, the instruction is the movement of a pointing device coupled to the second computing device, and the controller analyzes the movement of the pointing device to control the switch to select one of the first video signal and the second video signal.

In another embodiment, the remote access device further comprises a video processor to process one of the first video signal and the second video signal to obtain a processed video signal.

In another preferred embodiment of the present invention, a remote access device is installed on a first computing device with a first video interface to receive a first video signal. A second computing device may access the first computing device. The remote access comprises a second video source to provide a second video signal, a controller, a switch controlled by the controller to alternatively select one of the first video signal and the second video signal and a network interface, coupled to the switch and the controller, to transmit one of the first video signal and the second video signal, selected by the switch, to the second computing device.

In another embodiment, the remote access device further comprises a video processor to process one of the first video signal and the second video signal to obtain a processed video signal.

In another preferred embodiment, the present invention provides a method for remote accessing a device installed on a first computing device with a first video interface to receive a first video signal. A second computing device may access the first computing device. The method comprises: receiving a first video signal from the first video interface, receiving a second video signal from the second video source and outputting one of the first video signal and the second video signal to the second computing device through the network in response to a movement of a pointing device coupled to the second computing device analyzed by the controller.

Accordingly, two video signals from different video interfaces are sent to the switch circuit together. A switch circuit controlled by a processor outputs one of the first video signal and the second video signal to the remote user. Therefore, the two video signals may be combined together to create an extended display.

### BRIEF DESCRIPTION OF THE DRAWINGS

The invention may be more readily understood by referring to the accompanying drawings in which:

FIG. 1A illustrates a remote access device configured in accordance with one preferred embodiment of the present invention;

FIG. 1B illustrates a remote access device that is installed in a motherboard accordance with one preferred embodiment of the present invention;

FIG. 2A illustrates a schematic diagram that a second computing device 204 accesses a first computing device 201 through a network 206;

FIG. 2B illustrates the remote access device is installed in a motherboard of a first computing device; and

FIG. 3 illustrates a flow chart of the present invention for operating the remote access device in the FIG. 1.

### DETAILED DESCRIPTION OF THE PREFERRED EMBODIMENTS

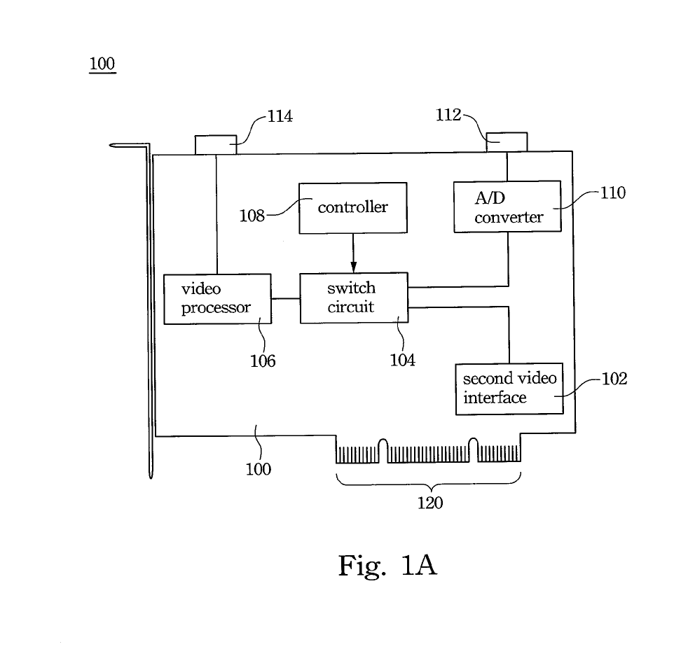

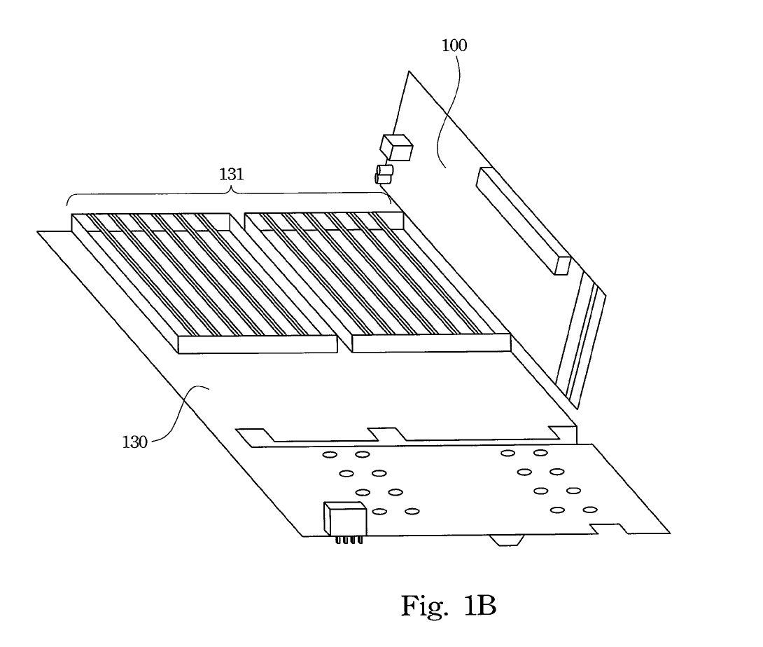

FIG. 1A illustrates a remote access device 100 configured in accordance with one preferred embodiment of the present invention. According to an embodiment, the remote access device 100 has an interface 120, such as a PCI Interface. Therefore, the remote access device 100 can be installed in a motherboard through the interface 120 of the motherboard.

FIG. 1B illustrates a schematic diagram of the remote access device 100 that is installed in a motherboard 130 through a slot 131, such as a PCI slot, on the motherboard 130. Through the slot 131, the remote access 100 may communicate with the motherboard 130.

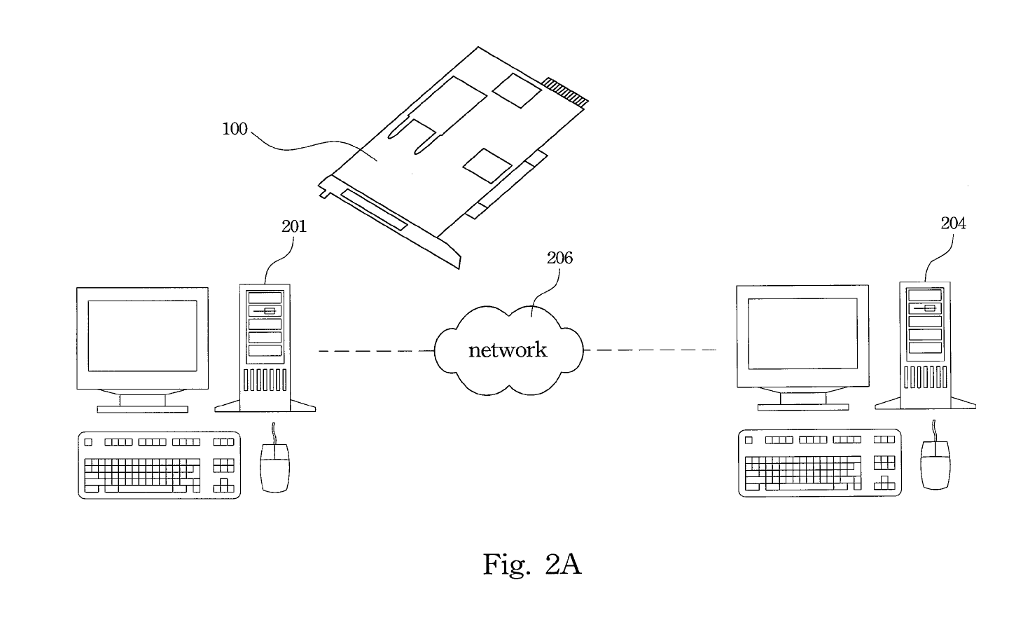

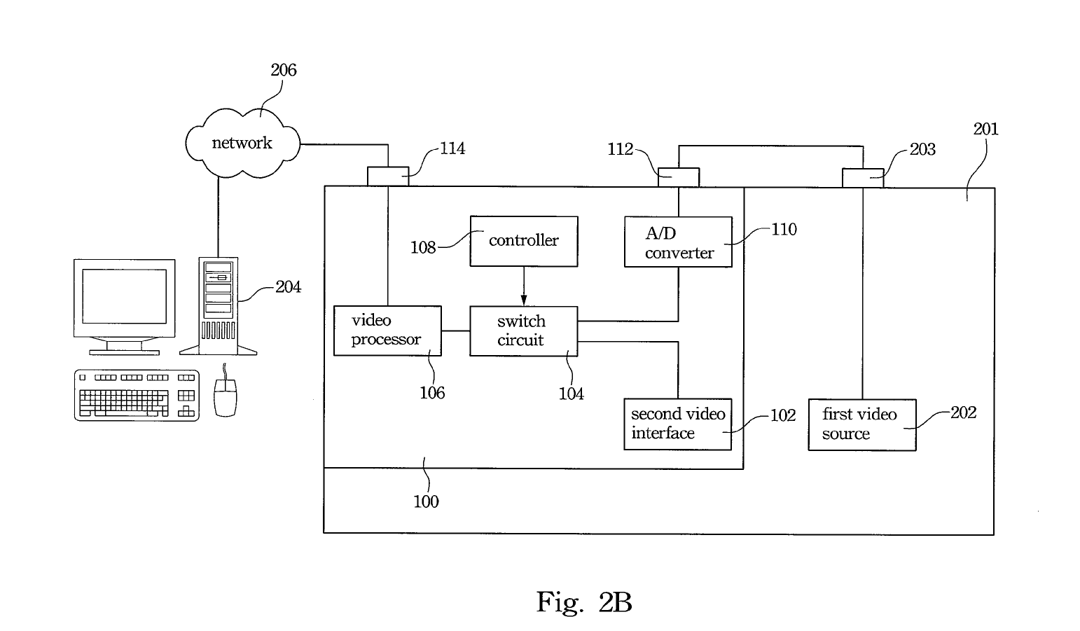

FIG. 2A illustrates a schematic diagram depicting a second computing device 204 accesses a first computing device 201 through a network 206. The remote access device 100 is installed in the motherboard of a first computing device 201. Through the remote access device 100, the remote second computing device 204 may access the first computing device 201. In an embodiment, the first computing device 201 can be a server or a PC. The second computing device 204 can be a PC.

FIG. 2B illustrates a schematic diagram of the remote access device 100 that is installed in a motherboard of a first computing device 201. The motherboard is not illustrated in the FIG. 2B. Please refer to FIG. 1A and FIG. 2B together. In an embodiment, the second computing device 204 may connect with the remote access device 100 to access the first computing device through a network 206. The motherboard of the first computing device 201 includes a first video source 202. The first video source 202 generates a first video signal to the signal port 203. The signal port 203 can be a video connector mounted on the backplate of the first computing device 201. The first video source 202 can be a graphic card installed on the motherboard or an on-board graphic chip or the like mounted on the motherboard. A first video interface 112 installed in the remote access device 100 receives the first video signal from the signal port 203.

The remote access device 100 further includes a second video source 102, a switch circuit 104, a video processor 106, a controller 108, a network interface 114 and the first video interface 112. The second video source 102 provides a second video signal. The second video source 102 can be a VGA controller or a graphic engine which receives command from the motherboard through the Interface 120. The first video signal from the first video interface 202 is transferred to the remote access device 100 through the first video interface 112. The switch circuit 104 controlled by the controller 108 is used to receive and select one of the first video signal and the second video signal to display. The video processor 106 is coupled to the switch circuit 104 to process a selected video signal from the switch circuit 104 to obtain a processed video signal. The video processor 106 may include a video grabber to grab some frames constituting the selected video signal. For example, the video grabber grabs 30 frames out of 60 frames. In one embodiment, the video processor 106 further includes a video compressor to compress the selected video signal from the switch circuit 104. The processed video signal is transferred to the network 206 through the network interface 114. The second computing device 204 may receive the processed video signal through the network 206.

In another embodiment, the remote access device 100 further includes an analog to digital (A/D) converter 110 interposed between the first video interface 112 and the switch circuit 104 to convert the first video signal from an analog signal to a digital signal when the first video signal is an analog signal. In other words, the A/D converter 110 can be omitted in some circumsatances. When the first video signal is a digital signal, the A/D converter 110 is omitted. Similarly, an A/D converter also can be disposed between the switch circuit 104 and the second video source 102 to convert the second video signal from an analog signal to a digital signal when the second video signal is an analog signal.

In an embodiment, a user may issue an instruction through the second computing device 204 to the first computing device 201 to select a video signal from the first video source 202 and the second video source 102 to display. The instruction comprises of the movement of a pointing device coupled to the second computing device 204. In this case, the controller 108 may analyze the movement of the pointing device to determine which video signal is selected, and based on the determination to control the switch circuit 104 to select one of the first video signal and the second video signal to be displayed on the display of the remote computer 204. For example, the first video signal may create a first image on the display and the second video signal may create a second image on the display. When the first image is shown on the display and when the user moves the pointing device coupled to the second computing device 204 to the boundary of the first image, the controller 108 may analyze the movement of the pointing device to switch the switch circuit 104 to select the second video signal to send to the video processor 106. Then, the video processor 106 may process the second video signal to obtain a processed video signal. Finally, the processed video signal is sent to the second computing device 204 through the network 206. In other words, the first image is switched to the second image, and the second image is shown on the display connected to the second computing device 204.

In another embodiment, the switch circuit 104 is automatically and periodically switched. In other words, it is not necessary for a user near the second computing device 204 to issue instruction to switch the switch circuit 104. In this case, the first video signal and the second video signal are alternately sent to the video processor 106. The video processor 106 may alternately process the first video signal and the second video signal and transmit the first processed video signal and the second processed video signal to the second computing device 204 through the network 206.

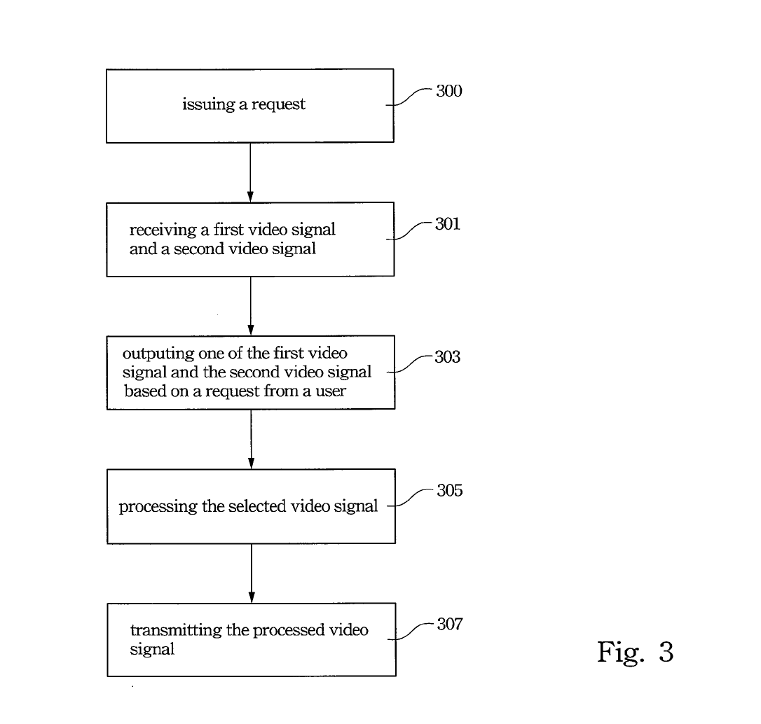

FIG. 3 illustrates a flow chart of the present invention for operating the remote access device 100 shown in the FIG. 1A to output a selected video signal from the first computing device 201 to the second computing device 204. Please refer to FIG. 2B and FIG. 3 together. The remote access device 100 is installed in the first computing device 201. According to the present invention, when the second computing device 204 issues a request to access the first computing device 201, in the step 301, a first video signal is received by the first video interface 112 and a second video signal is provided by the second video source 102. Then, a selecting step 303 is performed. In the step 303, one of the first video signal and the second video signal is selected based on the request from the second computing device 204. The selected video signal is outputted from the first computing device to the second computing device 204 through the network 206.

Accordingly, in the present invention, two video signals from different video sources are sent to the switch circuit 104 shown in FIG. 1A or FIG. 2B together. The switch circuit 104 is controlled by the controller 108 to output one of the first video signal and the second video signal to the remote computer 204. In other words, the two video signals may be combined together to create an extended display. Therefore, a remote user may issue a request signal to the controller 108 to switch the switch circuit 104 to output corresponding video signal of the extended display. As is understood by a person skilled in the art, the foregoing descriptions of the preferred embodiment of the present invention are an illustration of the present invention rather than a limitation thereof. Various modifications and similar arrangements are included within the spirit and scope of the appended claims. The scope of the claims should be accorded to the broadest interpretation so as to encompass all such modifications and similar structures. While a preferred embodiment of the invention has been illustrated and described, it will be appreciated that various changes can be made therein without departing from the spirit and scope of the invention

What is claimed is:

1. A remote access device, installed on a first computing device with a first video interface to receive a first video signal from a first video source, for allowing the first computing device to be accessed by a second computing device through a network, the remote access device comprising:
a second video source, providing a second video signal;
a controller;
a switch, controlled by the controller to select one of the first video signal and the second video signal based on an instruction from the second computing device; and
a network interface, coupled to the switch and the controller to transmit one of the first video signal and the second video signal selected by the switch, to the second computing device.

2. The remote access device according to claim 1, wherein the instruction further comprises movement of a pointing device coupled to the second computing device.

3. The remote access device according to claim 1, wherein the controller further analyzes the movement of the pointing device coupled to the second computing device to control the switch to selecting one of the first video signal and the second video signal.

4. The remote access device according to claim 1, wherein the first video signal comes from a graphic card installed or a video chip on the first computing device.

5. The remote access device according to claim 1, wherein the first video signal is received via a video connector on a backplate of the first computing device.

6. The remote access device according to claim 1, wherein the second video source further comprises a VGA controller or a graphic engine to provide the second video signal.

7. The remote access device according to claim 1, further comprises a video processor, disposed between the switch and the network interface, for processing one of the first video signal and the second video signal to obtain a processed video signal.

8. The remote access device according to claim 8, wherein the video processor further comprises a video compressor.

9. The remote access device according to claim 8, wherein the processed video signal is a compressed video signal.

10. A remote access device, installed on a first computing device with a first video interface, to receive a first video signal from a first video source, for allowing the first computing device to be accessed by a second computing device through a network, the remote access device comprising:
a second video source, to provide a second video signal;
a controller;
a switch, controlled by the controller, for alternately selecting one of the first video signal and the second video signal, and
a network interface, coupled to the switch and the controller, to transmit the first video signal or the second video signal, selected by the switch, to the second computing device.

11. The remote access device according to claim 10, wherein the first video signal comes from a graphic card or a video chip installed on the first computing device.

12. The remote access device according to claim 10, wherein the first video signal is received via a video connector on a backplate of the first computing device.

13. The remote access device according to claim 10, wherein the video processor further comprises a video grabber.

14. The remote access device according to claim 10, further comprises a video processor, disposed between the switch and the network interface, for processing one of the first video signal and the second video signal to obtain a processed video signal.

15. The remote access device according to claim 14, wherein the video processor further comprises a video compressor.

16. The remote access device according to claim 14, wherein the processed video signal is a compressed video signal.

17. A method for a remote access device, installed on a first computing device having a first video source, to allow the first computing device to be accessed by a second computing device through a network, the remote access device with a first video interface, a second video source and a controller, the method comprising:
receiving a first video signal from the first video source;
receiving a second video signal from the second video source; and
outputting one of the first video signal and the second video signal to the second computing device through the network in response to a movement of a pointing device coupled to the second computing device analyzed by the controller.

18. The method according to claim 17, wherein the first video signal comes from a graphic card or a video chip installed on the first computing device.

19. The method according to claim 17, wherein receiving the first video signal is through a video connector on a backplate of the first computing device.

20. The method according to claim 17, wherein the video processor further comprises a video grabber.

21. The method according to claim 17, further comprising a step to compress the first video signal and the second video signal.
